(19) United States
(12) Patent Application Publication
(10) Pub. No.: US 2009/0243165 A1
(43) Pub. Date: Oct. 1, 2009

(54) STOPPING MEMBER, FIRING FURNACE, AND METHOD FOR MANUFACTURING HONEYCOMB STRUCTURE

(75) Inventor: Yuichi HIROSHIMA, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/411,148

(22) Filed: Mar. 25, 2009

(30) Foreign Application Priority Data
Mar. 27, 2008 (JP) PCT/JP2008/055938

(51) Int. Cl. C04B 35/64; F23B 99/00

(52) U.S. Cl. 264/630; 110/349

(57) ABSTRACT

A stopping member includes a shaft rod and a stopper. The stopper is provided at an end of the shaft rod. The shaft rod and the stopper are arranged so that the stopping member forms a substantially linear shape upon passing through a through hole provided in a heat insulating layer which is provided to enclose a heater and a muffle to accommodate a ceramic molded body in a firing furnace. The stopper is configured to extend in a direction substantially perpendicular to the shaft rod so as to fix the heat insulating layer after the end of the shaft rod has passed through the through hole.

### CROSS-REFERENCE TO RELATED APPLICATIONS

The present application claims priority under 35 U.S.C. §119 to PCT Application No. PCT/JP2008/055938, filed Mar. 27, 2008, the contents of which are incorporated herein by reference in their entirety.

### BACKGROUND OF THE INVENTION

1. Field of the Invention

The present invention relates to a stopping member, a firing furnace, and a method for manufacturing a honeycomb structure.

2. Discussion of the Background

There have been proposed various honeycomb filters for purifying exhaust gases and various catalyst supporting carriers, which are configured to purify exhaust gases discharged from internal combustions of vehicles such as buses and trucks, construction machines, and the like.

A honeycomb structure including a porous body made of non-oxide ceramic such as silicon carbide having excellent heat resistance, is used as such a honeycomb filter for purifying exhaust gases and the like.

As conventional examples, WO 2006/016430 A1 and JP-A 63-302292 disclose a firing furnace for manufacturing this kind of non-oxide ceramic member.

As disclosed in WO 2006/016430 A1, the firing furnace for manufacturing such a non-oxide ceramic member includes: a muffle, a heating device, and the like in the firing furnace; and a heat insulating layer provided so as to enclose the muffle and the heating device thereinside.

The heat insulating layer is fixed by a stopping member in a firing furnace of this kind. Used for this stopping member are: the bolt and nut containing carbon excellent in heat resistance, as disclosed in WO 2006/016430 A1 and JP-A 63-302292; or the bolt and nut disclosed in JP-U 60-99352 (JP-U 62-8409).

The contents of WO 2006/016430 A1, JP-A 63-302292 and JP-U 60-99352 (JP-U 62-8409) are incorporated herein by reference in their entirety.

### SUMMARY OF THE INVENTION

According to one aspect of the present invention, a stopping member includes a shaft rod and a stopper. The stopper is provided at an end of the shaft rod. The shaft rod and the stopper are arranged so that the stopping member forms a substantially linear shape upon passing through a through hole provided in a heat insulating layer which is provided to enclose a heater and a muffle to accommodate a ceramic molded body in a firing furnace. The stopper is configured to extend in a direction substantially perpendicular to the shaft rod so as to fix the heat insulating layer after the end of the shaft rod has passed through the through hole.

According to another aspect of the present invention, a firing furnace includes a muffle, a heater, a heat insulating layer, and a plurality of stopping members. The muffle has a space to accommodate a ceramic molded body. The heater is disposed outside the muffle. The heat insulating layer is provided to enclose the muffle and the heater and has a through hole. The plurality of stopping members fix the heat insulating layer. At least one of the plurality of stopping members includes a shaft rod and a stopper. The stopper is provided at an end of the shaft rod. The shaft rod and the stopper are arranged so that the at least one of the plurality of stopping members forms a substantially linear shape upon passing through the through hole provided in the heat insulating layer. The stopper is configured to extend in a direction substantially perpendicular to the shaft rod so as to fix the heat insulating layer after the end of the shaft rod has passed through the through hole.

According to further aspect of the present invention, a method for manufacturing a honeycomb structure includes manufacturing a ceramic molded body. A firing furnace is provided and includes a muffle, a heater, a heat insulating layer, and a plurality of stopping members. The muffle has a space to accommodate a ceramic molded body. The heater is disposed outside the muffle. The heat insulating layer is provided to enclose the muffle and the heater and has a through hole. The plurality of stopping members fix the heat insulating layer. At least one of the plurality of stopping members includes a shaft rod and a stopper. The stopper is provided at an end of the shaft rod. The shaft rod and the stopper are arranged so that the at least one of the plurality of stopping members forms a substantially linear shape upon passing through the through hole provided in the heat insulating layer. The stopper is configured to extend in a direction substantially perpendicular to the shaft rod so as to fix the heat insulating layer after the end of the shaft rod has passed through the through hole. The manufactured ceramic molded body is transported into the firing furnace to fire the ceramic molded body to manufacture a ceramic fired body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a top view schematically illustrating one embodiment of a stopping member for a heat insulating layer according to the present invention, FIG. 1B is a front view of the stopping member, and FIG. 1C is a side view of the stopping member.

FIG. 2 is a partially enlarged side view schematically illustrating a portion of the stopping member for a heat insulating layer shown in FIG. 1C, on which a stopper is pivotally supported.

FIG. 3 is a cross-sectional view schematically illustrating a firing furnace in which the stopping member for a heat insulating layer according to the embodiment of the present invention shown in FIGS. 1A to 1C is used.

FIGS. 4A to 4C are explanatory views each schematically illustrating a way of providing in a heat insulating layer 23 a stopping member 10 for a heat insulating layer according to an embodiment of the present invention.

FIG. 5 is a perspective view schematically illustrating one example of a honeycomb structure obtained by a method for manufacturing a honeycomb structure according to an embodiment of the present invention.

FIG. 6A is a perspective view schematically illustrating a ceramic fired body used for the honeycomb structure shown in FIG. 5, and FIG. 6B is a B-B line cross-sectional view of FIG. 6A.

FIG. 7A is a front view schematically illustrating a second embodiment of a stopping member for a heat insulating layer according to the present invention, and FIG. 7(b) is a front view schematically illustrating an embodiment that further modifies the second embodiment of the stopping member for a heat insulating layer according to the present invention.

### DESCRIPTION OF THE EMBODIMENTS

Embodiments will now be described with reference to the accompanying drawings, wherein like reference numerals designate corresponding or identical elements throughout the various drawings.

A stopping member for a heat insulating layer according to an embodiment of the present invention is configured to fix a heat insulating layer in a firing furnace, the firing furnace including: a muffle formed so as to secure a space for accommodating a ceramic molded body; a heater disposed outside the muffle; and the heat insulating layer provided so as to enclose the muffle and the heater, the stopping member including: a shaft rod; and a stopper provided at an end of the shaft rod, wherein the stopping member is substantially linear upon passing through a through hole for a stopping member provided in the heat insulating layer, and after an end portion of the stopping member has passed through the through hole for a stopping member, the stopper extends in a direction substantially perpendicular to the shaft rod, and functions as a member for fixing the heat insulating layer.

The stopping member for a heat insulating layer according to the embodiment of the present invention is substantially linear upon passing through a through hole for a stopping member provided in a heat insulating layer. After an end portion of the stopping member has passed through the heat insulating layer, the stopper operates and extends in a direction substantially perpendicular to the shaft rod, and functions as a member for fixing the heat insulating layer.

Therefore, when an inconvenience occurs in the stopping member in the heat insulating layer provided in the firing furnace under operation, the stopping member is more easily repaired by using the stopping member for a heat insulating layer according to the embodiment of the present invention, without disassembling the equipment in the firing furnace such as in a heat insulating layer. That is, it becomes easier to replace the stopping member in the heat insulating layer and to fix the heat insulating layer with another stopping member of a heat insulating layer. For this reason, according to the stopping member for a heat insulating layer relating to the embodiment of the present invention, it becomes easier to efficiently fire a ceramic molded body without reducing the production efficiency of the firing furnace.

In addition, when a part of a damaged stopping member remains inside the through hole for a stopping member, the remaining part of the stopping member is more easily removed from the heat insulating layer by pushing the remaining part of the stopping member with an end portion of the stopping member for a heat insulating layer or a stopper. Consequently, it becomes easier to readily replace the stopping member without disassembling the equipment in the firing furnace.

In the stopping member for a heat insulating layer according to an embodiment of the present invention, the stopper that forms the stopping member may be substantially semi-cylindrical, and a central part of the stopper may be pivotally supported at the end of the shaft rod.

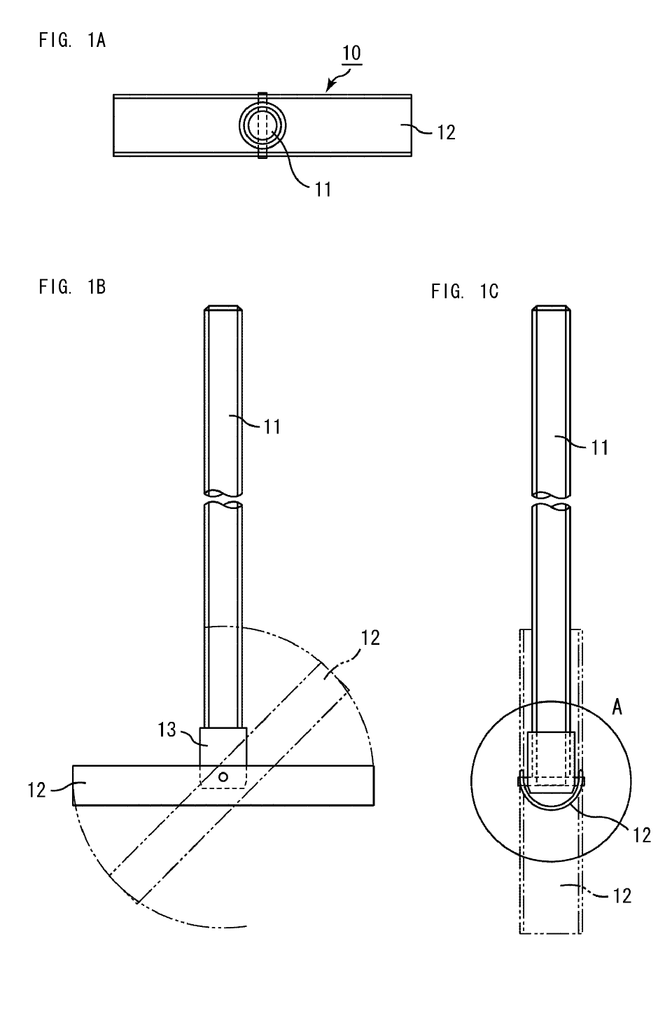

If the stopper that forms the stopping member according to the embodiment of the present invention is substantially semi-cylindrical and a central part of the stopper is pivotally supported at the end of the shaft rod, rotating the stopper so as to make the stopper substantially parallel with the shaft rod when the stopping member for a heat insulating layer passes through the through hole for a stopping member, the through hole provided in the heat insulating layer, makes a portion of the stopper cover the shaft rod, as illustrated in FIG. 1C, so that the shaft rod and the portion of the stopper are more easily integrated. Thereby, it becomes easier to make the stopping member for a heat insulating layer substantially linear. Therefore, the stopping member for a heat insulating layer is more likely to easily pass through the through hole for a stopping member by adopting the above-mentioned configuration. On the other hand, after the stopping member for a heat insulating layer passes therethrough, by utilizing the weight of the stopper and the like to make the stopper substantially perpendicular to the shaft rod (in a substantially T shape), attaching a nut to an end portion opposite to an end portion on which the stopper is provided, and fastening the nut, it becomes easier to tightly fix the stopping member for a heat insulating layer to the heat insulating layer. This facilitates a rapid repair of the heat insulating layer (replacement of the stopping member).

It is desirable that the shaft rod of the stopping member for a heat insulating layer according to an embodiment of the present invention contain carbon.

In the stopping member for a heat insulating layer according to the embodiment of the present invention, if the shaft rod of the stopping member contains carbon, the stopping member for a heat insulating layer tends to have heat resistance and to maintain mechanical strength even at a high temperature, and the reaction of the stopping member for a heat insulating layer and gases in the firing furnace tends not to proceed, leading to excellent durability.

The shaft rod of the stopping member for a heat insulating layer according to an embodiment of the present invention may contain substantially the same material as a material of ceramic powder contained in the ceramic molded body.

In the stopping member for a heat insulating layer according to the embodiment of the present invention, if the shaft rod of the stopping member contains substantially the same material as a material of ceramic powder contained in the ceramic molded body, the possibility is low that other impurities are mixed in the ceramic molded body upon firing a ceramic molded body, and it becomes easier to manufacture a ceramic fired body excellent in quality. Moreover, the reaction of the stopping member for a heat insulating layer according to the embodiment of the present invention and gases in the firing furnace hardly proceeds, resulting in excellent durability.

It is desirable that the stopper of the stopping member for a heat insulating layer according to an embodiment of the present invention contains carbon, metal, or ceramic.

In the stopping member for a heat insulating layer according to the embodiment of the present invention, when a heat insulating layer is fixed using the stopping member for a heat insulating layer, since the stopper is located outside the heat insulating layer, the stopper has a low temperature and the gases generated by firing are less likely to reach the outside of the heat insulating layer. Even when the end portion of the stopper contains carbon, metal, or ceramic, the stopper is less susceptible to gases generated by firing, and it thus becomes easier to fix the heat insulating layer for a long period of time.

A firing furnace according to an embodiment of the present invention includes: a muffle formed so as to secure a space for accommodating a ceramic molded body; a heater disposed outside the muffle; a heat insulating layer provided so as to enclose the muffle and the heater; and a plurality of stopping members for heat insulating layers configured to fix the heat insulating layer, wherein the above-described stopping member for a heat insulating layer is used as at least one of the plurality of stopping members.

In the firing furnace according to the embodiment of the present invention, the above-described stopping member for a heat insulating layer is used as at least one of the plurality of stopping members. Even in the firing furnace after the repair of replacing the stopping member, the heat insulating layer is likely to be normally fixed by the stopping member, and it becomes easier to fire a ceramic molded body without any difficulty in the same manner as before the repair and therefore to manufacture a ceramic fired body excellent in quality.

It is desirable that the heat insulating layer of the firing furnace according to an embodiment of the present invention include a plurality of heat insulating layers, and that an outermost layer of the plurality of heat insulating layers include a carbon fiber layer.

In the firing furnace according to the embodiment of the present invention, if the outermost layer of the plurality of heat insulating layers includes a carbon fiber layer excellent in heat insulating property, the heat insulating layer tends to have excellent heat insulating property, and it becomes easier to fire a ceramic molded body efficiently.

A method for manufacturing a honeycomb structure according to an embodiment of the present invention includes the steps of: manufacturing a ceramic molded body; and transporting the manufactured ceramic molded body into the above-described firing furnace, and firing the ceramic molded body to manufacture a ceramic fired body.

In the method for manufacturing a honeycomb structure according to the embodiment of the present invention, since the firing furnace according to the embodiment of the present invention is used, it becomes easier to fire a ceramic molded body without any difficulty in the same manner as before the repair of the stopping member even after the repair of replacing the stopping member, to manufacture a ceramic fired body excellent in quality, and thus to manufacture a honeycomb structure having less variations in characteristics by using one or a plurality of the ceramic fired bodies.

In the method for manufacturing a honeycomb structure according to an embodiment of the present invention, it is desirable that the ceramic fired body contain a silicon carbide material.

In the method for manufacturing a honeycomb structure according to the embodiment of the present invention, if the ceramic fired body contains a silicon carbide material, it becomes easier to manufacture a honeycomb structure excellent in heat resistance and mechanical property.

When the firing furnace having the structure including a conventional stopping member is used for a long period of time, oxidation reaction of the stopping member proceeds because of gases and the like that have been emitted by the reaction upon firing a non-oxide ceramic member in the portion near the outside of the heat insulating material in the heat insulating layer, and therefore the stopping member may deteriorate mechanically and chemically and break and the like. Since these breaks and the like make it more difficult to fix a heat insulating material, there is problem that the heat deformation and the like of the heat insulating layer tend to occur and the heat insulating property tends to be significantly lowered, and thereby the quality of the fired products tends to vary.

When a stopping member breaks as thus described, it is desirable to replace the stopping member. In contrast, when the stopping member is made of a bolt and a nut, it is necessary to insert the bolt in a through hole for inserting a bolt in a heat insulating material, thereafter screw the nut from the inside and outside of the heat insulating material, and tighten the heat insulating material by rotating this nut.

However, regarding the firing furnace in which the heat insulating layer and the like have been installed, it is often difficult to screw a nut from the outside of a heat insulating layer unless the heat insulating layer and its peripheral equipment are removed. Since it is impossible to use a firing furnace for a long period of time when the removal task of the heat insulating layer and the like is once performed, production efficiency thereof is problematically lowered. Especially the removal of the heat insulating layer at the lower side of the firing furnace is an extremely difficult task.

An embodiment of the present invention is: a stopping member for a heat insulating layer having a new structure of a stopping member for fixing a heat insulating layer which is easily replaceable in a short period of time even in the case where inconveniences, such as breaks, arise in the stopping member for fixing a heat insulating layer; a firing furnace using the stopping member for an insulating member; and a method for manufacturing a honeycomb structured body using the firing furnace.

### FIRST EMBODIMENT

Referring to the drawings, the following will describe a stopping member for a heat insulating layer according to a first embodiment of the present invention, a firing furnace including the stopping member for a heat insulating layer, and a method for manufacturing a honeycomb structure using the firing furnace.

FIG. 1A is a top view schematically illustrating one embodiment of a stopping member for a heat insulating layer according to the present invention, FIG. 1B is a front view of the stopping member, and FIG. 1C is a side view of the stopping member.

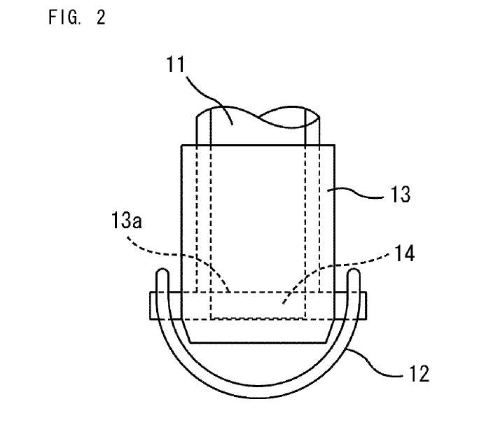

FIG. 2 is a partially enlarged side view schematically illustrating a portion (A) of the stopping member for a heat insulating layer shown in FIG. 1C, on which a stopper is pivotally supported.

As illustrated in FIGS. 1A to 1C, a stopping member 10 for a heat insulating layer according to the present embodiment mainly includes a shaft rod 11 and a stopper 12 provided at the end of the shaft rod 11. More specifically, as illustrated in FIG. 2, the stopper supporting member 13 having a substantially cylindrical shape with a bottom is provided and fixed at the end of the shaft rod 11, a through hole 13a for passing the supporting pin 14 therethrough in the vicinity of the bottom of the stopper supporting member 13 is formed, and the supporting pin 14 rotatably passes through the through hole 13a. Moreover, the inner part of the substantially semi-cylindrical stopper 12 is fixed to both ends of the supporting pin 14 by a method such as welding. The position where the supporting pin 14 is fixed is the central part of the stopper 12, and therefore, the stopper 12 including the supporting pin 14 is rotatably supported in a through hole portion of the stopper supporting member 13 fixed to the shaft rod 11.

Since the stopping member 10 for a heat insulating layer has such a structure, as illustrated in FIG. 1B, the stopper 12 is pivotable around the pivotally supported portion. The stopper 12 may extend in a direction perpendicular to a longitudinal direction of the shaft rod 11, that is, in a substantially T shape; alternatively, the stopper 12 may be in parallel with the longitudinal direction of the shaft rod 11, that is, in a substantially linear shape.

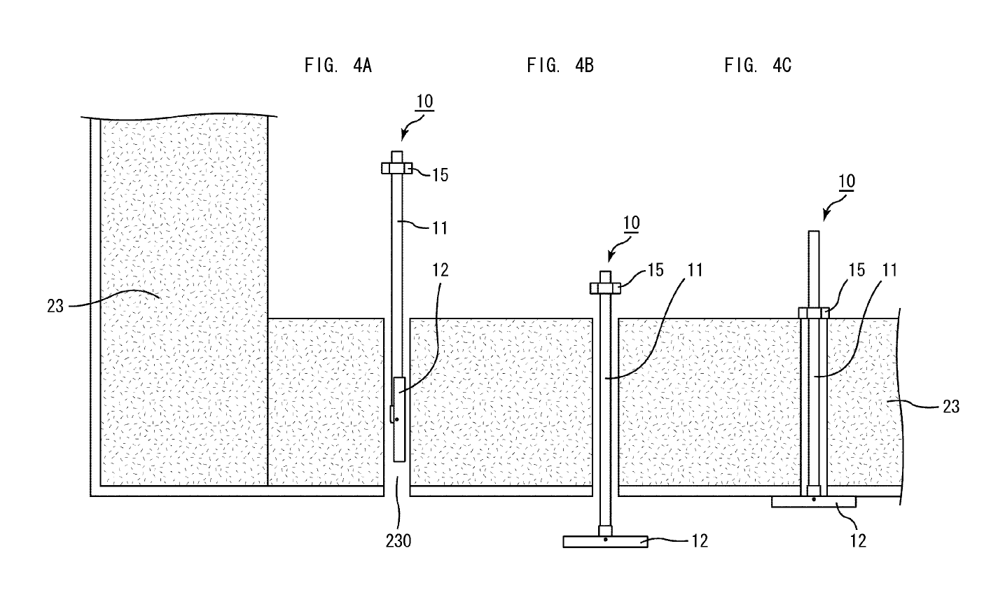

The shaft rod 11 of the stopping member 10 for a heat insulating layer contains carbon, both ends of this shaft rod 11 are threaded, and it is possible to thread a nut 15 (see FIG. 4A) containing carbon, and also to thread a stopper supporting member 13 containing metal.

Moreover, the stopper 12, the stopper supporting member 13, and the supporting pin 14 are located outside the heat insulating layer 23 (see FIG. 4C) upon being attached to the heat insulating layer 23, are less likely to directly contact corrosive gases generated by firing and the like and are less susceptible to degradation such as oxidation, and may contain metals such as SUS, titanium, and aluminum.

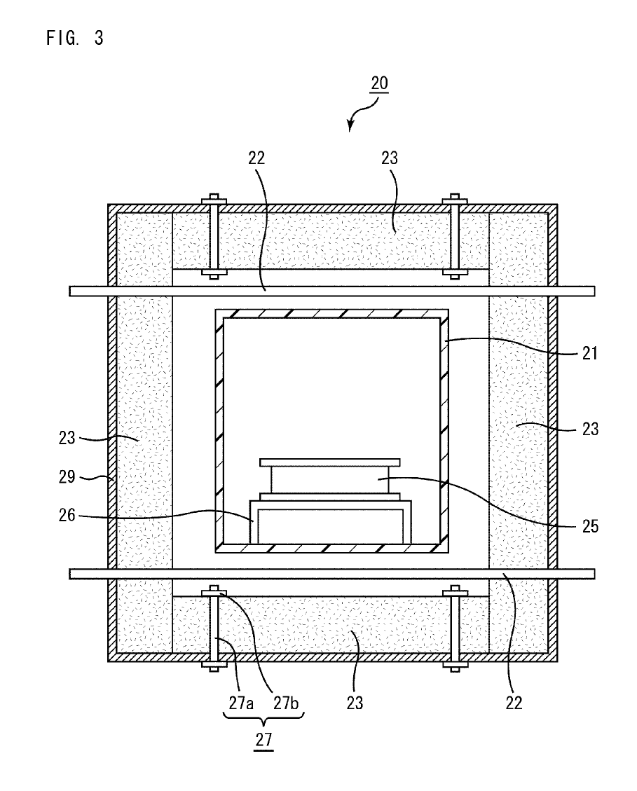

FIG. 3 is a cross-sectional view schematically illustrating a firing furnace in which the stopping member for a heat insulating layer according to an embodiment of the present invention shown in FIGS. 1A to 1C is used.

The firing furnace 20 includes: a muffle 21 formed so as to secure a space for accommodating a molded body to be fired; a heating device 22 disposed over and under the peripheral portion of the muffle 21; a heat insulating layer 23 disposed outside the muffle 21 and the heating device 22; a member 29 for fixing and enclosing a heat insulating layer which is disposed on the peripheral portion of the heat insulating layer 23 and configured to fix the heat insulating layer 23, and further, a furnace wall (not illustrated) containing metal and the like is formed on the outermost part, which enables isolation from the surrounding atmosphere. Here, the heat insulating layer 23 is fixed to the member 29 for fixing and enclosing a heat insulating layer by the stopping member 27 (a bolt 27a and a nut 27b) containing carbon.

The furnace wall may be a water-cooling jacket configured so that water may circulate inside the furnace wall. The heating device 22 may be provided over and under the muffle 21, or may be provided on the right and left of the muffle 21.

The entire floor portion of the muffle 21 is supported by a supporting member (not illustrated), and the firing jig 25 inside which a molded body for firing is placed can pass through the muffle 21. The heating device 22 containing graphite and the like is installed around the peripheral portion of the muffle 21, and this heating device 22 is connected to an external power supply (not illustrated) via a terminal. In addition, the heat insulating layer 23 is formed further outside the heating device 22.

In this firing furnace 20, since the stopping member 27 for fixing the heat insulating layer 23 contains carbon (or the stopping member 27 may contain a metal covered with carbon), it becomes easier to prevent the reaction of the heat insulating layer 23 and the stopping member 27. Here, the heat insulating layer 23 may be layers having carbon as a constituent material, and its constitution is not particularly limited.

As illustrated in FIG. 3, upon firing in the firing furnace 20 having such a constitution, a ceramic molded body containing porous ceramics is accommodated in the firing jig 25, transported in the firing furnace 20 while placed on the supporting base 26, and fired while allowing the ceramic molded body to pass through the firing furnace 20 at a specific velocity.

In the firing furnace 20, a heating device 22 is provided over and under the muffle 21 at a predetermined interval. In the process where the firing jig 25 passes through the firing furnace 25, with the heat of this heating device 22, the firing furnace 20 is configured to gradually raise its temperature, and gradually lower its temperature after reaching the maximum temperature. The supporting base 26 on which the firing jig 25 has been placed is continuously transported from the inlet into the firing furnace 20. The ceramic molded body is sintered while allowing the supporting base 26 to pass through the firing furnace 20 at a specific velocity, and thereafter the firing jig 25 having a lowered temperature is carried out from the outlet to manufacture a ceramic fired body.

However, when the stopping member 27 is used in the firing furnace having the above-mentioned structure for a long period of time, since the corrosive gases generated by firing promote a reaction with the stopping member 27 in the portion in the vicinity of the outside of the heat insulating layer in the heat insulating layer, the stopping member 27 may deteriorate mechanically and chemically and break and the like; thus, it is necessary to replace the stopping member 27.

However, it is often difficult to screw a nut 27b onto a bolt 27a from the outside of a heat insulating layer 23 unless the heat insulating layer 23 and its peripheral equipment are removed in the firing furnace 20 as illustrated in FIG. 3. Since it is impossible to use a firing furnace for a long period of time when the removal task of the heat insulating layer and the like is once performed, production efficiency thereof is problematically lowered. Especially the removal of the heat insulating layer 23 at the lower side of the firing furnace is an extremely difficult task.

In the embodiment of the present invention, it becomes easier to replace a stopping member easily and quickly by using the stopping member 10 for a heat insulating layer according to the embodiment of the present invention.

FIGS. 4A to 4C are explanatory views each schematically illustrating a way of providing in a heat insulating layer 23 a stopping member 10 for a heat insulating layer according to the embodiment of the present invention.

Upon providing the stopping member 10 for a heat insulating layer in the heat insulating layer 23, a nut 15 is first screwed onto the upper end of the stopping member 10 for a heat insulating layer, and a stopper 12 is set so that the stopping member 10 for a heat insulating layer having this nut 15 is substantially linear. That is, the stopper 12 is moved so that approximately half of the substantially semi-cylindrical stopper 12 covers a substantially round-pillar shaped shaft rod 11, and the entire stopping member 10 for a heat insulating layer is made substantially linear (see FIG. 4A).

This substantially linear stopping member 10 for a heat insulating layer is inserted in the through hole 230 for a stopping member formed in the heat insulating layer 23, as illustrated in FIG. 4A. Here, in the case where a part of a damaged stopping member 27 remains inside the through hole 230 for a stopping member at this time, the remaining part of the stopping member 27 is removed from the heat insulating layer 23 by pushing the end of the stopping member 10 for a heat insulating layer or the stopper 12.

Next, as illustrated in FIG. 4B, the shaft rod 11 is moved so that the entire stopper 12 passes through the heat insulating layer 23. Then, as illustrated in FIG. 4C, the stopper 12 is brought into a substantially horizontal state so that the entire stopping member 10 for a heat insulating layer can be in a substantially T shape; and the heat insulating layer 23 is likely to be firmly fixed by the stopping member 10 for a heat insulating layer by screwing a nut 15, and deformation and the like are likely to be prevented in the heat insulating layer 23 upon firing a ceramic molded body. In the method for disposing a stopping member 10 for a heat insulating layer illustrated in FIGS. 4A to 4C, a nut 15 is not necessarily screwed on a stopping member 10 for a heat insulating layer from the onset, but the nut 15 may be screwed on the stopping member 10 for a heat insulating layer afterwards (upon being fixed).

Thus, by using a firing furnace having the stopping member 10 for a heat insulating layer according to the embodiment of the present invention, it becomes easier to fire a ceramic molded body in the same manner as before the repair of the stopping member, thereby more easily obtaining a ceramic fired body. A honeycomb structure can be obtained by combining a plurality of these ceramic fired bodies with an adhesive and carrying out processing, and the like, thereon.

Next, a method for manufacturing the honeycomb structure according to the present embodiment will be described.

The molding process is performed in which a ceramic molded body is manufactured by extrusion molding a wet mixture containing ceramic powder and a binder.

First, silicon carbide powders having different average particle diameters as a ceramic raw material, an organic binder, a plasticizer in liquid form, a lubricant and the like, and water are mixed to prepare a wet mixture for manufacturing a ceramic molded body.

Subsequently, the wet mixture is loaded into an extrusion molding machine.

When the wet mixture is loaded into the extrusion molding machine, the wet mixture is extrusion-molded into a pillar-shaped ceramic molded body in a predetermined shape having a plurality of cells.

Next, the ceramic molded body is cut into a predetermined length, and dried by using a drying apparatus, such as a microwave drying apparatus, a hot-air drying apparatus, a dielectric drying apparatus, a reduced-pressure drying apparatus, a vacuum drying apparatus and a freeze drying apparatus, and thereafter, a sealing process is carried out by filling predetermined cells with a plug material paste to be a plug for sealing the cells.

Here, conditions conventionally used upon manufacturing a ceramic fired body are applicable for carrying out the cutting process, the drying process and the sealing process.

Subsequently, the degreasing process is performed of heating an organic matter in a ceramic molded body in a degreasing furnace, and decomposing and removing the organic matter.

The degreased body of the thus obtained ceramic molded body is transported into the above-mentioned firing furnace according to the embodiment of the present invention and fired in a non-oxidizing atmosphere to manufacture a ceramic fired body.

Thereafter, an aggregate with a plurality of ceramic fired bodies being bonded to one another by interposing adhesive layers is formed through a method in which an adhesive paste layer is formed by applying an adhesive paste on side faces of a plurality of ceramic fired bodies and the resulting honeycomb fired bodies are combined sequentially, a method in which each of the honeycomb fired bodies is temporally fixed in a molding frame having substantially the same shape as the shape of the ceramic block to be manufactured and an adhesive paste is injected into each of the gaps between the honeycomb fired bodies, or the like; and if necessary, a side face of the aggregate is processed by using a diamond cutter or the like to form a ceramic block having a round pillar shape, a rectangular pillar shape, or the like.

Moreover, a coating process is carried out to form a coat layer on the periphery of the ceramic block formed by applying a sealing material paste to the periphery of the ceramic block, then drying and solidifying the sealing material paste.

As a constituent material of the adhesive paste and that of the sealing material paste, it is possible to employ substantially the same material used upon manufacturing a honeycomb molded body. Moreover, the constituent material of the adhesive paste may be the same or different from that of the sealing material paste.

Through the above-mentioned processes, a substantially round pillar-shaped honeycomb structure can be manufactured in which a coat layer is formed on the periphery of a ceramic block including a plurality of honeycomb fired bodies bonded to one another with an adhesive layer interposed therebetween.

Here, the coat layer does not necessarily need to be formed, and may be formed on demand.

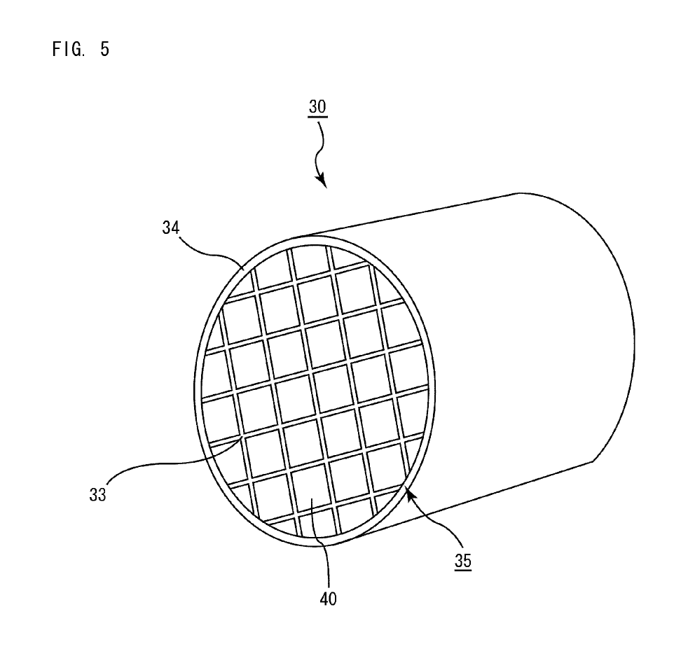

FIG. 5 is a perspective view schematically illustrating one example of a honeycomb structure obtained by a method for manufacturing a honeycomb structure of the present invention.

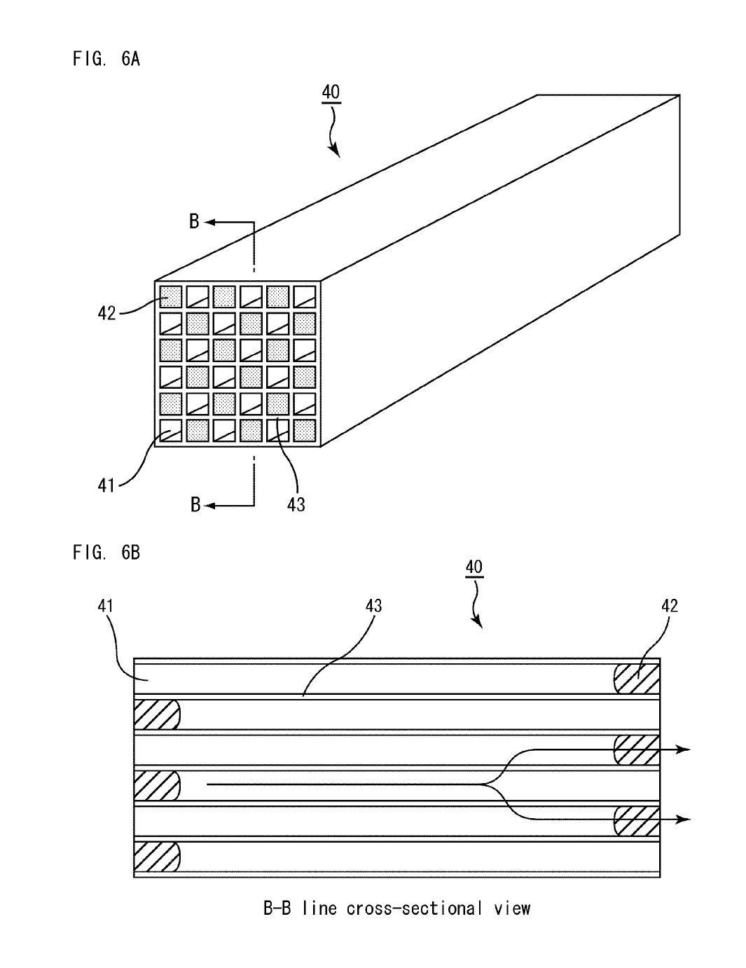

FIG. 6A is a perspective view schematically illustrating a ceramic fired body used for the honeycomb structure shown in FIG. 5, and FIG. 6B is a B-B line cross-sectional view of FIG. 6A.

In this honeycomb structure 30, a plurality of ceramic fired bodies 40 are combined with one another by interposing adhesive layers 33, and sealing material layers 34 are formed around the periphery of this ceramic block 35. Moreover, in this ceramic fired body 40, a plurality of cells 41 are longitudinally disposed in parallel with one another, and the cell wall 43 that partitions the cells 41 is allowed to function as a particle capturing filter.

In other words, each of the cells 41 formed in the ceramic fired body 40 has either one of the end portions on the inlet side or the outlet side of exhaust gases sealed with the plug 42 as illustrated in FIG. 6B so that exhaust gases that have flowed into one of the cells 41 are allowed to flow out of another cell 41 after surely having passed through a cell wall 43 that separates the cells 41. When exhaust gases pass through the cell wall 43, particulates are captured by the cell wall 43 so that the exhaust gases are purified.

The actions and effects of a stopping member for a heat insulating layer, a firing furnace provided with the stopping member for a heat insulating layer, and a method for manufacturing a honeycomb structure using the firing furnace, according to the first embodiment, will be described.

(1) The stopping member for a heat insulating layer according to the present embodiment is substantially linear upon passing through a through hole for a stopping member provided in the heat insulating layer. After an end portion of the stopping member has passed through the heat insulating layer, the operation of the stopper forms the stopping member for a heat insulating layer into a substantially T shape, and screwing a nut on the stopper enables the stopper to function as a member for fixing the heat insulating layer.

Therefore, when an inconvenience occurs in the stopping member of a heat insulating layer provided in the firing furnace under operation, it becomes easier to repair the stopping member by using the stopping member for a heat insulating layer according to the embodiment of the present invention, without disassembling the equipment in the firing furnace such as in a heat insulating layer. That is, it becomes easier to replace the stopping member of a heat insulating layer and fix the heat insulating layer with another stopping member of the heat insulating layer. For this reason, according to the stopping member for a heat insulating layer relating to the embodiment of the present invention, a ceramic molded body is more likely to be fired efficiently without reducing the production efficiency of the firing furnace.

In addition, even if a part of a damaged stopping member remains inside the through hole for a stopping member, the remaining part of the stopping member is more easily removed from the heat insulating layer by pushing the remaining part of the stopping member with the end of the stopping member for a heat insulating layer or the stopper, and it thus becomes easier to readily repair the stopping member without disassembling the equipment in the firing furnace.

(2) In the firing furnace according to the present embodiment, since the stopping member for a heat insulating layer according to the embodiment of the present invention is used as at least one of the plurality of stopping members. Even in the firing furnace after the repair of replacing the stopping member, the heat insulating layer is likely to be normally fixed by the stopping member, it becomes easier to fire a ceramic molded body without any difficulty in the same manner as before the repair of the stopping member, and thus to manufacture a ceramic fired body excellent in quality.

(3) In the method for manufacturing a honeycomb structure according to the present embodiment, since the firing furnace according to the embodiment of the present invention is used, it becomes easier to fire a ceramic molded body without any difficulty in the same manner as before the repair of the stopping member even after the repair of replacing the stopping member by the stopping member for a heat insulating layer according to the embodiment of the present invention, to manufacture a ceramic fired body excellent in quality, and thus to obtain a honeycomb structure excellent in its performance by using the ceramic fired body.

### EXAMPLES

The following will describe Examples that more specifically disclose the first embodiment of the present invention, and embodiments of the present invention should not be intended to be limited only to these Examples.

In the following Examples and Comparative Examples, honeycomb structures were manufactured by the method according to the above-described embodiment and a conventional method, and performance tests were conducted on the obtained honeycomb structures to observe the change of performance of the honeycomb structures.

### Example 1

(1) A firing furnace illustrated in FIG. 3 was manufactured, and the heat insulating layer 23 was used as a heat insulating layer including: an inner layer including a carbon member (FR200/OS manufactured by Kureha Corporation, density: 0.16 g/cm³, thickness: 100 mm) was used as a heat insulating layer 23; and an outer layer including a carbon fiber layer (density: 0.1 g/cm³, thickness: 25 mm). And a ceramic fired body was manufactured under the conditions of the maximum temperature of 2200° C. inside the muffle in an argon atmosphere at a normal pressure.

Here, each member that formed a heat insulating layer had an impurity concentration of 0.1% by weight or less, the stopping member 27 containing carbon provided in the heat insulating layer 23 also had an impurity concentration of 0.1% by weight or less.

(2) In other words, 60% by weight oft-type silicon carbide powder having an average particle diameter of 10 μm and 40% by weight of a-type silicon carbide powder having an average particle diameter of 0.5 μm were wet-mixed. To 100 parts by weight of the resulting mixture, 5 parts by weight of an organic binder (methylcellulose) and 10 parts by weight of water were added and kneaded. Thereafter, a small amount of a plasticizer and a lubricant were added and further kneaded to prepare a wet mixture, and extrusion-molded to manufacture a raw molded body.

(3) Next, the raw molded body was dried by using a microwave drying apparatus, a paste having the same composition as that of the raw molded body was filled into a predetermined through hole, and thereafter dried again by using the microwave drying apparatus, and degreased at 400° C. The firing furnace was used to perform firing at 2200° C. under an argon atmosphere at a normal pressure for 3 hours so as to manufacture a ceramic fired body having a shape shown in FIG. 6A and being formed by a silicon carbide sintered body with a size of 34 mm×34 mm×300 mm, the number of cells of 31 pcs/cm² and a thickness of the cell wall of 0.3 mm.

(4) When the process for manufacturing the ceramic fired body using this firing furnace 20 was performed continuously for 2500 hours, the three stopping members 27 including the stopping member 27 disposed at the lower side of the firing furnace was oxidized, the bolt 27a of the stopping member 27 at the lower side was particularly damaged and cut into two. Then, a part of the bolt 27a located inside and the nut 27b were successfully pulled out from the inside; on the other hand, a part of the bolt 27b located outside and the nut 27b were still located inside the heat insulating layer 23.

(5) By using the stopping member 10 for a heat insulating layer illustrated in FIG. 1, the part of the bolt 27b located outside and the nut 27b were removed the heat insulating layer 23 by pushing the end portion including the stopper 12, and these were completely removed. Then, the heat insulating layer 23 was firmly fixed to a member 29 for fixing and enclosing a heat insulating layer using this stopping member 10 for a heat insulating layer.

(6) Thereafter, by using the firing furnace provided with three stopping members 10 for heat insulating layers as thus provided, the process of manufacturing a ceramic fired body was performed continuously for 2000 hours to manufacture a ceramic fired body 40.

(7) After this, by using the above-mentioned method, a ceramic block 35 was formed by combining a plurality of ceramic fired bodies 40 (see FIG. 6A) containing silicon carbide by interposing an adhesive layer 33, as illustrated in FIG. 5, to manufacture a honeycomb structure 30 in which a sealing material layer 34 was formed on the periphery of this ceramic block 35.

The obtained honeycomb structures 30, when manufactured at any time point, had the designed properties.

### Comparative Example 1

After conducting the processes (1) to (4) in Example 1 and finding that the stopping member was destroyed, the end of the nut 27a that forms the stopping member 27 was cut down instead of replacing the stopping member 27, and formed into a nail shape. Subsequently, the nut 27a was obliquely driven into the heat insulating layer 23 to temporally fix the heat insulating layer 23. Then, the process for manufacturing a ceramic fired body was continuously performed for 2500 hours under the same conditions as in Example 1 to manufacture a ceramic fired body 40.

Thereafter, a honeycomb structure 30 was manufactured in the same manner as in the process (7) in Example 1. After completion of manufacturing the ceramic fired body, deformation was found in the entire heat insulating layer when the heat insulating layer was observed.

Here, the manufactured honeycomb structure had larger variations in properties depending on the period of time when the honeycomb structure was manufactured; and the properties were changed. It is considered that the change is attributed to a subtle change of the temperature or the like around the periphery of the molded body that is to be manufactured in a firing furnace.

### SECOND EMBODIMENT

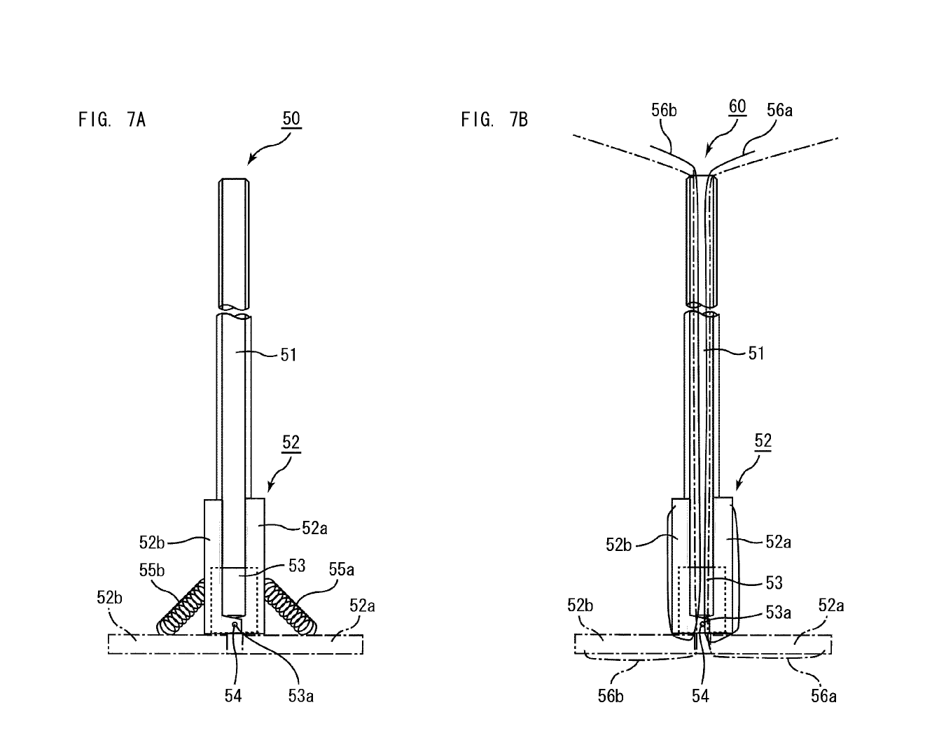

FIG. 7A is a front view schematically illustrating the second embodiment of a stopping member for a heat insulating layer according to the present invention, and FIG. 7B is a front view schematically illustrating an embodiment in which further modifications have been made on the second embodiment of the stopping member for a heat insulating layer according to the present invention.

As illustrated in FIG. 7A, a stopping member 50 for a heat insulating layer according to the present embodiment mainly includes a shaft rod 51 and stoppers 52 (52a, 52b) provided at the end of the shaft rod 51. More specifically, a stopper supporting member 53 having a substantially cylindrical shape with a bottom is provided and fixed at the end of the shaft rod 51, a through hole 53a for inserting the supporting pin 54 is formed in the vicinity of the bottom of the stopper supporting member 53, and the supporting pin 54 rotatably passes through the through hole 53a. Moreover, the end portions of the substantially semi-cylindrical two stoppers 52a and 52b are pivotally fixed to the supporting pin 54, and the springs 55a and 55b are attached between the stopper supporting member 53 and the stoppers 52a and 52b.

That is, one long stopper 12 is used in the first embodiment; in contrast, in the second embodiment, a stopper is divided into two parts, and two stoppers 52a and 52b are inwardly folded along the shaft rod 51, thereby allowing the stopping member 50 to be substantially linear (indicated by solid lines) . Moreover, since the springs 55a and 55b are attached between the stopper supporting member 53 and the stoppers 52a and 52b, in the case where the force for inwardly folding the stoppers 52a and 52b does not act, the stoppers 52a and 52b extend in a direction substantially perpendicular to the shaft rod 51 (indicated by dashed lines) . Here, in the case where the stoppers 52a and 52b extend in a direction substantially perpendicular to the shaft rod 51, since the two stoppers 52a and 52b are overlapped with each other in the vicinity of the central part of the stoppers 52a and 52b and do not extend any more, the two stoppers 52a and 52b remain substantially in parallel with each other.

Since the stopping member 50 for a heat insulating layer has such a configuration, when it is inserted in the through hole 230 for a stopping member (see FIG. 4A), the force for inwardly folding the two stoppers 52a and 52b acts and the stopping member 50 tends to be substantially linear. When the two stoppers 52a and 52b pass through the through hole 230 for a stopping member, the force of the springs 55a and 55b is more likely to cause the stoppers 52a and 52b to extend in a direction substantially perpendicular to the shaft rod 51, that is, in a substantially T shape.

The shaft rod 51 of the stopping member 50 for a heat insulating layers contains carbon, screws are threaded at both ends of this shaft rod 51, and the nut 15 (refer to FIG. 4A) and the stopper supporting member 53 each also containing carbon can be screwed.

When attached to the heat insulating layer 23 (see FIG. 4C), the stopper 52, the stopper supporting member 53, and the supporting pin 54 are located outside the heat insulating layer 23, and are less likely to directly contact corrosive gases and the like emitted by firing, and can be formed by metals such as SUS, titanium, and aluminum because degradation such as oxidation is less likely to occur.

The operation of this stopping member 50 for a heat insulating layer is the same as that of the first embodiment. As illustrated in FIGS. 4A to 4C, after the entire stopping member 50 for a heat insulating layer is made substantially linear, it is inserted in a through hole 230 for a stopping member formed in the heat insulating layer 23. Here, in the case where a part of a damaged stopping member 27 remains inside the through hole 230 for a stopping member, the remaining part of the stopping member 27 is removed from the heat insulating layer 23 by using the stopping member 50 for a heat insulating layer.

Next, the shaft rod 51 is moved so that the stoppers 52a and 52b may pass through the heat insulating layer 23. Then, the stoppers 52a and 52b are expanded to be brought into a substantially horizontal state so that the entire stopping member 50 for a heat insulating layer can be in a substantially T shape as a result of the action of force of springs 55a and 55b; and the heat insulating layer 23 is more likely to be firmly fixed by the stopping member 50 for a heat insulating layers by screwing a nut 15.

Thus, by using a firing furnace having the stopping member 50 for a heat insulating layer, it becomes easier to fire a ceramic molded body in the same manner as before the repair of the stopping member, and thereby to obtain a ceramic fired body. A honeycomb structure can be obtained by combining a plurality of these ceramic fired bodies.

As described above, FIG. 7B illustrates an embodiment in which further modifications have been made on the second embodiment of the stopping member for a heat insulating layer according to the present invention. That is, as illustrated in FIG. 7B, in the stopping member 60 for a heat insulating layer, metal wires 56a and 56b, instead of the springs 55a and 55b, are attached in the vicinity of both ends of the stoppers 52a and 52b, the wires 56a and 56b passing through the inside of the shaft rod 51 from the upper side thereof. After passing the wires 56a and 56b through a through hole 230 for a stopping member (see FIG. 4A) with the stoppers 52a and 52b being inwardly folded (indicated by solid lines), the wires 56a and 56b are pulled, thereby enabling the stoppers 52a and 52b to extend in a direction substantially perpendicular to the shaft rod 51 (in a state indicated by dashed lines), that is, a stopping member for a heat insulating layer in a substantially T shape. Here, in the case where the stoppers 52a and 52b extend in a direction substantially perpendicular to the shaft rod 11, since the two stoppers 52a and 52b are overlapped with each other in the vicinity of the central part of the two stoppers 52a and 52b and do not extend any more, the two stoppers 52a and 52b remain substantially in parallel with each other.

The actions and effects of a stopping member for a heat insulating layer, a firing furnace provided with the stopping member for a heat insulating layer, and a method for manufacturing a honeycomb structure using the firing furnace, according to the second embodiment, will be described.

(1) The stopping member for a heat insulating layer according to the present embodiment is substantially linear upon passing through a through hole for a stopping member provided in the heat insulating layer. After an end portion of the stopping member has passed through the heat insulating layer, the operation of the stopper forms the stopping member for a heat insulating layer into a substantially T shape, and screwing a nut on the stopper enables the stopping member for a heat insulating layer to function as a member for fixing the heat insulating layer.

Therefore, it becomes easier to repair the stopping member by using the stopping member for a heat insulating layer according to the embodiment of the present invention, without disassembling the equipment in the firing furnace such as in a heat insulating layer. Accordingly, It becomes easier to efficiently fire a ceramic molded body without reducing the production efficiency of the firing furnace.

In addition, even when a part of a stopping member remains inside the through hole for a stopping member, it becomes easier to remove the part of the stopping member from the heat insulating layer, and thus to readily replace the stopping member without disassembling the equipment in the firing furnace.

(2) In the firing furnace according to the present embodiment, since the stopping members 50 and 60 for heat insulating layers illustrated in FIGS. 7A and 7B are used as at least one of the plurality of stopping members, the heat insulating layer even after the repair of replacing the stopping member is likely to be normally fixed by the stopping member, it becomes possible to fire a ceramic molded body without any difficulty in the same manner as before the repair of the stopping member, and thus to manufacture a ceramic fired body excellent in quality.

(3) In the method for manufacturing a honeycomb structure according to the present embodiment, since the firing furnace having a stopping member 50 for an insulating layer is used, it becomes easier to fire a ceramic molded body without any difficulty in the same manner as before the repair of the stopping member even after the repair of replacing the stopping member, to manufacture a ceramic fired body excellent in quality, and thus to obtain a honeycomb structure excellent in its performance using the ceramic fired body.

### OTHER EMBODIMENTS

The stopper that forms the stopping member for a heat insulating layer according to embodiments of the present invention is not particularly limited in its shape as long as: it is substantially linear upon passing through a through hole for a stopping member provided in the heat insulating layer; and after an end portion of the stopping member has passed through the through hole for a stopping member, the stopper extends in a direction substantially perpendicular to the shaft rod and functions as a member for fixing the heat insulating layer. Therefore, the stopper may be made of one member in a substantially semi-cylindrical shape as described in the first embodiment, may be made of two members as described in the second embodiment, or may be made of three, four, or more members.

In the case where a stopper is made of four members, a stopper having the same configuration as in FIGS. 7A and 7B is used, except that, instead of the substantially semi-cylindrical member illustrated in FIGS. 7A and 7B, there is employed a member having the shape in which a cylinder is divided into four equal parts so as to include the axis of this cylinder. The stopper is configured so that: in the case where the stopping members for a heat insulating layer are made substantially linear, these stoppers are inwardly folded so as to enclose the shaft rod; and after passing through an heat insulating layer, the respective stoppers extend in a direction substantially perpendicular to the shaft rod as if an umbrella opened.

In the above-mentioned embodiment, although the shaft rod of the stopping member for a heat insulating layer contains carbon, the shaft rod of the stopping member for a heat insulating layer may contain substantially the same material as a material of the ceramic powder mainly contained in the ceramic molded body to be fired.

In the embodiments of the present invention, the ceramic powder mainly contained in the ceramic molded body to be fired is used to obtain the ceramic fired body. Examples of the ceramic powder, which is mainly contained in the ceramic molded body to be used to obtain the ceramic fired body, include: nitride ceramics such as aluminum nitride, silicon nitride, boron nitride, and titanium nitride; carbide ceramics such as silicon carbide, zirconium carbide, titanium carbide, tantalum carbide and tungsten carbide; oxide ceramics such as alumina, zirconia, cordierite, mullite and silica; and the like.

When ceramic powder contains the above-mentioned ceramics, the shaft rod of the stopping member for a heat insulating layer may contain substantially the same material.

In the case where the shaft rod containing such a material is used, there is a low possibility that other impurities mix in the ceramic molded body upon firing the ceramic molded body, and it becomes easier to manufacture a ceramic fired body having small variations and excellent quality.

The stopper contains metal in the above-mentioned embodiment. The stopper may contain carbon, or ceramics such as the above-mentioned nitride ceramic, carbide ceramic, and oxide ceramic.

This is because, since the stopper, the stopper supporting member, and the supporting pin are located outside a heat insulating layer upon fixing the heat insulating layer by using the stopping member for a heat insulating layer, their temperatures decrease, the gases emitted by firing are less likely to reach the outside of the heat insulating layer, and it becomes easier to fix the heat insulating layer for a long period of time even by using the stopper, the stopper supporting member, and the supporting pin each containing carbon, metal or ceramic. In particular, nitride ceramics, carbide ceramics, and the like each having excellent heat resistance have high strength, and can be suitably used as a stopper and the like.

The fired body obtainable by firing in the firing furnace according to the embodiments of the present invention is not particularly limited, and as described above, examples thereof include a nitride ceramic fired body, a carbide ceramic fired body, and the like. The firing furnace according to the embodiments of the present invention is suitable for manufacturing a non-oxide ceramic member, especially for manufacturing a non-oxide ceramic fired body such as silicon carbide.

The fired body may contain silicon-containing ceramics obtainable by blending metallic silicon into silicon carbide, and the ceramics in which silicon carbides are combined by silicon or a silicate compound. Upon adding metallic silicon, it is desirable to add 0 to about 45% by weight thereof with respect to the total weight.

The heat insulating layer used in the firing furnace according to the embodiments of the present invention may be one layer or multilayer. The layer including a carbon fiber layer or a carbon member can be used as the heat insulating layer. The carbon fiber layer is sheet-formed or woven by using carbon fibers such as carbon felt and carbon cloth, and carbon fibers may be bonded to one another by an inorganic adhesive, etc. The carbon fiber layer preferably has a density of from about 0.05 g/cm³ to about 5 g/cm³. The carbon fiber layer desirably has a thickness of from about 1 mm to about 100 mm.

The material of the layer including a carbon member is not particularly limited. One such example is a material obtained by compression forming carbon fibers and the like into a plate shape, and its density is preferably from about 0.1 g/cm³ to about 5 g/cm³. Moreover, the layer including a carbon member desirably has a thickness of from about 5 mm to about 100 mm. It is desirable to provide a carbon fiber layer on the outermost layer of the heat insulating layer.

The stopping member for a heat insulating layer according to the embodiments of the present invention may be used in combination with the conventionally used stopping member.

The carbon material that forms the heat insulating layer to be used in the embodiments of the present invention, the carbon material that forms the stopping member for a heat insulating layer used in the embodiments of the present invention, and the carbon material that forms the conventionally used stopping member desirably have a high purity. For example, the impurity concentration in a carbon material is desirably about 0.1% by weight or less, and more desirably about 0.01% by weight or less.

The firing furnace 10 desirably has an inert gas atmosphere, or an atmosphere of argon, nitrogen, etc.

Here, in the firing furnace according to the embodiments of the present invention, the heater used for firing is not limited to a heater that is configured to generate heat by connecting an external power to a carbon member and directly sending current and heat an object to be heated; and the heater may function as a heating device by the induction heating system. That is, the system may be such that: a carbon member serving as both a heating device and muffle is disposed in the vicinity of an object to be heated, for example, a heat insulating layer is disposed immediately outside the carbon member and a coil is provided outside the heat insulating layer; and by applying an alternative current to the coil, an eddy current is generated in the carbon member; thus, the temperature of the carbon member is raised to heat an object to be heated.

In the embodiments of the present invention, a plurality of honeycomb molded bodies may be accommodated in the above-mentioned firing jig, and the firing jigs may be laminated in a plurality of stages of firing jigs.

The shape of the honeycomb structure according to the embodiments of the present invention obtained by the above-described method is not particularly limited to a round pillar shape, and may have a pillar shape or a rectangular pillar shape having a flat shape such a cylindroid shape on its cross section.

In the honeycomb structure according to the embodiments of the present invention obtained by the above-described method, an end portion of each of the cells is not necessarily sealed. When it is not sealed, the honeycomb structure can be used as a catalyst supporting carrier capable of supporting the catalyst for converting exhaust gases for converting the toxic components, such as HC, CO, and NOx in exhaust gases.

The catalyst for converting exhaust gases is not particularly limited, and examples thereof include noble metals such as platinum, palladium, and rhodium. These noble metals may be used independently, or two or more of these may be used in combination.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by letters patent of the united states is:

1. A stopping member comprising:
a shaft rod; and
a stopper provided at an end of the shaft rod, the shaft rod and the stopper being arranged so that the stopping member forms a substantially linear shape upon passing through a through hole provided in a heat insulating layer which is provided to enclose a heater and a muffle to accommodate a ceramic molded body in a firing furnace, the stopper being configured to extend in a direction substantially perpendicular to the shaft rod so as to fix the heat insulating layer after the end of the shaft rod has passed through the through hole.

2. The stopping member according to claim 1,
wherein
the stopper is substantially semi-cylindrical, and
a central part of the stopper is rotatably supported at the end of said shaft rod.

3. The stopping member according to claim 1,
wherein
the shaft rod of said stopping member comprises carbon.

4. The stopping member according to claim 1,
wherein
the shaft rod of said stopping member comprises substantially a same material as a material of ceramic powder contained in the ceramic molded body.

5. The stopping member according to claim 1,
wherein
the shaft rod of said stopping member is covered with carbon.

6. The stopping member according to claim 1,
wherein
a stopper supporting member having a substantially cylindrical shape is provided at the end of said shaft rod, and said stopper is provided on said stopper supporting member.

7. The stopping member according to claim 6,
wherein
both ends of said shaft rod, a nut, and said stopper supporting member are threaded so as to allow said stopper supporting member to be screwed onto the end of said shaft rod and allow the nut to be screwed onto an opposite end of said shaft rod.

8. The stopping member according to claim 1,
wherein
the stopper of said stopping member comprises at least one of carbon, metal, and ceramic.

9. The stopping member according to claim 1,
wherein
said stopper comprises one member.

10. The stopping member according to claim 6,
wherein
said stopper comprises two members, and one end portion of each member is rotatably provided on said stopper supporting member so as to allow said stopping member to be substantially linear when the two members are folded inwardly along said shaft rod.

11. The stopping member according to claim 10,
wherein
springs each are attached between said stopper supporting member and one of the two members of said stopper, and between said stopper supporting member and another member of said stopper.

12. The stopping member according to claim 10,
wherein
a metal wire passes through the inside of said shaft rod from one end to the another end, comes out from a stopper-fixed end portion of said stopper supporting member, and is fixed on a face of one of the members of said stopper on an unfixed end portion side, said face being on a side opposite to a face that faces said stopper supporting member.

13. A firing furnace comprising:
a muffle having a space to accommodate a ceramic molded body;
a heater disposed outside the muffle;
a heat insulating layer provided to enclose said muffle and said heater and having a through hole; and
a plurality of stopping members which fix said heat insulating layer, at least one of said plurality of stopping members comprising:
a shaft rod; and
a stopper provided at an end of the shaft rod, the shaft rod and the stopper being arranged so that said at least one of said plurality of stopping members forms a substantially linear shape upon passing through the through hole provided in the heat insulating layer, the stopper being configured to extend in a direction substantially perpendicular to the shaft rod so as to fix the heat insulating layer after the end of the shaft rod has passed through the through hole.

14. The firing furnace according to claim 13,
wherein
said heat insulating layer comprises a plurality of heat insulating layers, and
an outermost layer of said plurality of heat insulating layers comprises a carbon fiber layer.

15. The firing furnace according to claim 13,
wherein
the stopper of said stopping member is substantially semi-cylindrical, and
a central part of the stopper is rotatably supported at the end of said shaft rod.

16. The firing furnace according to claim 13,
wherein
the shaft rod of said stopping member comprises carbon.

17. The firing furnace according to claim 13,
wherein
the shaft rod of said stopping member comprises substantially a same material as a material of ceramic powder contained in the ceramic molded body.

18. The firing furnace according to claim 13,
wherein
the shaft rod of said stopping member is covered with carbon.

19. The firing furnace according to claim 13,
wherein
a stopper supporting member having a substantially cylindrical shape is provided at the end of said shaft rod of said stopping member, and said stopper is provided on said stopper supporting member.

20. The firing furnace according to claim 19,
wherein
both ends of said shaft rod of said stopping member, a nut, and said stopper supporting member are threaded so as to allow said stopper supporting member to be screwed onto the end of said shaft rod and allow the nut to be screwed onto an opposite end of said shaft rod.

21. The firing furnace according to claim 13,
wherein
the stopper of said stopping member comprises at least one of carbon, metal, and ceramic.

22. The firing furnace according to claim 13,
wherein
said stopper of said stopping member comprises one member.

23. The firing furnace according to claim 19,
wherein
said stopper of said stopping member comprises two members, and one end portion of each member is rotatably provided on said stopper supporting member so as to allow said stopping member to be substantially linear when the two members are folded inwardly along said shaft rod.

24. The firing furnace according to claim 23,
wherein
springs each are attached between said stopper supporting member and one of the two members of said stopper of said stopping member, and between said stopper supporting member and another member of said stopper.

25. The firing furnace according to claim 23,
wherein
a metal wire passes through the inside of said shaft rod of said stopping member from one end to the another end, comes out from a stopper-fixed end portion of said stopper supporting member, and is fixed on a face of one of the members of said stopper on an unfixed end portion side, said face being on a side opposite to a face that faces said stopper supporting member.

26. The firing furnace according to claim 13,
wherein
said furnace has an inert gas atmosphere.

27. The firing furnace according to claim 26,
wherein
said inert gas atmosphere is an atmosphere of argon or nitrogen.

28. A method for manufacturing a honeycomb structure, the method comprising:
manufacturing a ceramic molded body;
providing a firing furnace comprising:
a muffle having a space to accommodate a ceramic molded body;
a heater disposed outside the muffle;
a heat insulating layer provided to enclose said muffle and said heater and having a through hole; and
a plurality of stopping members which fix said heat insulating layer, at least one of said plurality of stopping members comprising:
a shaft rod; and
a stopper provided at an end of the shaft rod, the shaft rod and the stopper being arranged so that said at least one of said plurality of stopping members forms a substantially linear shape upon passing through the through hole provided in the heat insulating layer, the stopper being configured to extend in a direction substantially perpendicular to the shaft rod so as to fix the heat insulating layer after the end of the shaft rod has passed through the through hole; and
transporting the manufactured ceramic molded body into the firing furnace to fire the ceramic molded body to manufacture a ceramic fired body.

29. The method for manufacturing a honeycomb structure according to claim 28,
wherein
the stopper of said stopping member is substantially semi-cylindrical, and
a central part of the stopper is rotatably supported at the end of said shaft rod.

30. The method for manufacturing a honeycomb structure according to claim 28,
wherein
the shaft rod of said stopping member comprises carbon.

31. The method for manufacturing a honeycomb structure according to claim 28,
wherein
the shaft rod of said stopping member comprises substantially a same material as a material of ceramic powder contained in the ceramic molded body.

32. The method for manufacturing a honeycomb structure according to claim 28,
wherein
the shaft rod of said stopping member is covered with carbon.

33. The method for manufacturing a honeycomb structure according to claim 28,
wherein
a stopper supporting member having a substantially cylindrical shape is provided at the end of said shaft rod of said stopping member, and said stopper is provided on said stopper supporting member.

34. The method for manufacturing a honeycomb structure according to claim 33,
wherein
both ends of said shaft rod of said stopping member, a nut, and said stopper supporting member are threaded so as to allow said stopper supporting member to be screwed onto the end of said shaft rod and allow the nut to be screwed onto the another end of said shaft rod.

35. The method for manufacturing a honeycomb structure according to claim 28,
wherein
the stopper of said stopping member comprises at least one of carbon, metal, and ceramic.

36. The method for manufacturing a honeycomb structure according to claim 28,
wherein
said stopper of said stopping member comprises one member.

37. The method for manufacturing a honeycomb structure according to claim 33,
wherein
said stopper of said stopping member comprises two members, and one end portion of each member is rotatably provided on said stopper supporting member so as to allow said stopping member to be substantially linear when the two members are folded inwardly along said shaft rod.

38. The method for manufacturing a honeycomb structure according to claim 37,
wherein
springs each are attached between said stopper supporting member and one of the two members of said stopper of said stopping member, and between said stopper supporting member and another member of said stopper.

39. The method for manufacturing a honeycomb structure according to claim 37,
wherein
a metal wire passes through the inside of said shaft rod of said stopping member from one end to the another end, comes out from a stopper-fixed end portion of said stopper supporting member, and is fixed on a face of one of the members of said stopper on an unfixed end portion side, said face being on a side opposite to a face that faces said stopper supporting member.

40. The method for manufacturing a honeycomb structure according to claim 28,
wherein
said furnace has an inert gas atmosphere.

41. The method for manufacturing a honeycomb structure according to claim 40,
wherein
said inert gas atmosphere is an atmosphere of argon or nitrogen.

42. The method for manufacturing a honeycomb structure according to claim 28,
wherein
said ceramic fired body comprises at least one of a nitride ceramic, a carbide ceramic, and an oxide ceramic.

43. The method for manufacturing a honeycomb structure according to claim 28,
wherein
said ceramic fired body comprises a silicon carbide material.

44. The method for manufacturing a honeycomb structure according to claim 28,
wherein
said ceramic fired body comprises
a silicon-containing ceramic in which a silicon carbide is blended with metallic silicon, or
a ceramic in which a silicon carbide is bonded by silicon or a silicate compound.
